(19) United States
(12) Patent Application Publication
(10) Pub. No.: US 2010/0201724 A1
(43) Pub. Date: Aug. 12, 2010

(54) LIQUID DISCHARGE APPARATUS AND METHOD OF CONTROLLING LIQUID DISCHARGE APPARATUS

(75) Inventors: Shunji YAMAGUCHI, Kanagawa (JP); Hitoshi KAMODA, Kanagawa (JP); Shigeyoshi HIRASHIMA, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/693,819

(22) Filed: Jan. 26, 2010

(30) Foreign Application Priority Data
Feb. 12, 2009 (JP) 2009-030535

(51) Int. Cl. B41J 29/38; B41J 2/165

(52) U.S. Cl. 347/9; 347/30; 347/31

(57) ABSTRACT

A liquid discharge apparatus includes: a plurality of nozzles that discharges liquid; a liquid discharge head that includes nozzle arrays where the respective nozzles are arranged in one direction; a liquid adsorbent that adsorbs liquid attached to a portion of the liquid discharge head where the nozzle arrays are formed; a moving means for relatively moving the liquid adsorbent in an arrangement direction of the nozzles; and a liquid suction means for sucking liquid adsorbed in the liquid adsorbent.

### BACKGROUND OF THE INVENTION

1. Field of the Invention

The present invention relates to a liquid discharge apparatus that does not deteriorate cleaning performance when cleaning a liquid discharge head where nozzle arrays for discharging liquid are formed, and a method of controlling the liquid discharge apparatus.

2. Description of the Related Art

A liquid discharge apparatus such as an inkjet printer forms an image on a recording sheet by discharging liquid from nozzle arrays that are formed at a liquid discharge head. For this reason, if an image is formed while a liquid discharge surface (a portion where the nozzle arrays are formed) of the liquid discharge head is contaminated or liquid or dirt is attached to the liquid discharge surface, printing quality deteriorates. In particular, if ink, which has a color different from the colors of existing ink (liquid), may flow back from nozzles in the case of an inkjet printer that manages full color, the color of the ink is mixed to the colors of the existing ink (liquid), so that mixed color ink is discharged during printing. As a result, image quality deteriorates.

Accordingly, in the past, various techniques, which clean a liquid discharge surface of a liquid discharge head, have been proposed in order to prevent the deterioration of printing quality. For example, a rubber blade method, which slides a slightly hard rubber blade over the liquid discharge surface while pushing the rubber blade against the liquid discharge surface, removes contaminations, standing ink, thickened or solidified ink, and the like, which are attached to the liquid discharge surface, by wiping them off. As a result, the discharge of ink is restored or discharge performance is stabilized.

However, ink attached to the liquid discharge surface is apt to remain in the rubber blade method, so that a sufficient cleaning effect may not be obtained. In particular, since a line inkjet printer includes a line head where head chips for discharging ink (liquid) are arranged side by side so as to correspond to a printing width, an ink discharge surface (liquid discharge surface) is wide. For this reason, it is difficult to uniformly push the rubber blade against the entire ink discharge surface, so that wiping is not sufficient. Further, among line heads, there is a line head where stepped portions are formed on an ink discharge surface. In the case of this kind of line head, it may not be possible to remove ink that remains at the stepped portions.

FIGS. 14A and 14B are cross-sectional views showing a state where a line head 120 is being cleaned by a rubber blade method in the related art, as seen from the side surface.

As shown in FIG. 14A, a rubber blade method makes a rubber blade 141 come into contact with an ink discharge surface 121 of a line head 120 and moves the rubber blade 141 along the ink discharge surface 121 in an arrangement direction of nozzles like an arrow, thereby wiping off standing ink and the like that are attached to the ink discharge surface 121. Therefore, it is necessary that the rubber blade 141 uniformly comes into contact with the ink discharge surface 121 without a gap.

Meanwhile, if a stepped portion is formed on the ink discharge surface 121 as shown in FIG. 14B, a gap is formed between a corner of the stepped portion and the rubber blade 141 that comes into press contact with the ink discharge surface 121 and is bent. Accordingly, the rubber blade 141 does not come into contact with the corner of the stepped portion. For this reason, it may not be possible to wipe off residual ink attached to the gap or dirt and foreign materials that are pushed to the corner of the stepped portion by the movement of the rubber blade 141.

Accordingly, there is known a wiping roller method that slides or rotationally moves not the rubber blade 141 but a cleaning roller (not shown), which is made of a foam material excellent in water adsorbability, on an ink discharge surface 121, so as to adsorb residual ink attached to the corner of the stepped portion of the ink discharge surface 121. According to this method, the porous foam forming the cleaning roller is recessed so as to correspond to the stepped portion, so that a gap may not be formed at the corner of the stepped portion. Further, since a pore (cell) formed in the porous foam generates a capillary force, it may be possible to clean the ink discharge surface while adsorbing standing ink and the like attached to the ink discharge surface 121 by the capillary force.

However, in the wiping roller method, water of the ink, which is once adsorbed in a flexible porous foam forming the cleaning roller and held in the porous foam, is hardly evaporated. Accordingly, time is necessary for drying the porous foam. For this reason, whenever cleaning is performed, water is adsorbed in the porous foam. As a result, the porous foam is saturated with water, so that the adsorbability of the porous foam deteriorates. In addition, if the porous foam is saturated with water, ink held in the cleaning roller is transferred to the ink discharge surface 121. For this reason, there is a concern that the ink discharge surface 121 is contaminated.

Accordingly, there is known a technique that prevents the deterioration of adsorbability and can restore cleaning performance. For example, there have been disclosed a technique that collects ink adsorbed in the cleaning roller by guiding the ink to an absorber for maintenance, and a technique that restores water adsorbability by mechanically wringing the cleaning roller and the like.

These techniques are disclosed, for example, in JP-A-2002-361879, JP-A-4-187449, Japanese Patent No. 2728913, and JP-B-4-75131.

### SUMMARY OF THE INVENTION

However, in the technique that collects the ink by the absorber for maintenance, the absorber for maintenance should not be saturated with water. For this reason, it is necessary that a large-sized absorber for maintenance is used or the absorber for maintenance is frequently replaced. Further, since the cleaning roller or the cleaning belt is repeatedly wrung in the technique that mechanically wrings the cleaning roller and the like, the deterioration or damage of the cleaning roller or the cleaning belt is caused. For this reason, there is a problem in durability. Furthermore, the ink wrung from the cleaning roller or the cleaning belt should not be sucked again into the cleaning roller or the cleaning belt, which causes mechanical complication.

Thus, it is desirable to restore cleaning performance without replacement and a harmful influence on durability.

According to one embodiment of the invention, there is provided a liquid discharge apparatus. The liquid discharge apparatus includes a plurality of nozzles that discharges liquid, a liquid discharge head that includes nozzle arrays where the respective nozzles are arranged in one direction, a liquid adsorbent that adsorbs liquid attached to a portion of the liquid discharge head where the nozzle arrays are formed, a moving means for relatively moving the liquid adsorbent in an arrangement direction of the nozzles, and a liquid suction means for sucking liquid adsorbed in the liquid adsorbent.

According to the one embodiment, it may be possible to relatively move the liquid adsorbent in the arrangement direction of the nozzles by the moving means. Accordingly, the liquid, which is attached to the portion of the liquid discharge head where the nozzle arrays are formed, is adsorbed in the liquid adsorbent. The liquid adsorbed in the liquid adsorbent is sucked by the liquid suction means.

Further, according to another embodiment of the invention, there is a provided a method of controlling a liquid discharge apparatus. A liquid suction means of the another embodiment sucks liquid from the liquid adsorbent when the amount of liquid adsorbed in the liquid adsorbent is larger than a predetermined amount. Furthermore, the another embodiment includes a liquid collecting body that can collect liquid adsorbed in the liquid adsorbent, and the liquid suction means sucks liquid from the liquid collecting body when the amount of liquid collected in the liquid collecting body is larger than a predetermined amount. In addition, a moving means of the another embodiment moves the liquid adsorbent so that the liquid adsorbent comes into contact with the liquid collecting body, and a liquid suction means sucks liquid when the liquid adsorbent comes into contact with the liquid collecting body.

According to this embodiment of the invention, liquid is sucked by the liquid suction means when the amount of the liquid of the liquid adsorbent or the liquid collecting body is larger than a predetermined amount. Accordingly, the liquid adsorbent or the liquid collecting body is not saturated with liquid. Further, according to this embodiment of the invention, liquid is sucked by the liquid suction means when the liquid adsorbent comes into contact with the liquid collecting body. Accordingly, whenever the liquid adsorbent comes into contact with the liquid collecting body, the liquid adsorbent is restored.

According to the embodiments of the invention, liquid, which is attached to a portion of a liquid discharge head where nozzle arrays are formed, is adsorbed in a liquid adsorbent, so that the liquid discharge head is cleaned. Further, liquid adsorbed in the liquid adsorbent or liquid collected in the liquid collecting body is sucked by a liquid suction means. Accordingly, it may be possible to restore cleaning performance without replacement of a liquid adsorbent and the like and without a harmful influence on durability of the liquid adsorbent and the like.

### BRIEF DESCRIPTION OF THE DRAWINGS

FIG. 1 is a front view showing the entire configuration of an inkjet printer as a liquid discharge apparatus according to an embodiment (first embodiment) of the invention, and shows the state of the inkjet printer during printing;

FIG. 2 is a front view showing the entire configuration of the inkjet printer as the liquid discharge apparatus according to the embodiment (first embodiment) of the invention, and shows the state of the inkjet printer during standby;

FIG. 3 is a front view showing the entire configuration of the inkjet printer as the liquid discharge apparatus according to the embodiment (first embodiment) of the invention, and shows the state of the inkjet printer during cleaning;

FIG. 4 is a plan view of a line head of the inkjet printer shown in FIGS. 1 to 3, and is a view as seen from an ink discharge surface;

FIG. 5 is an exploded perspective view of each head module of the line head shown in FIG. 4;

FIG. 6A is a perspective view of the head module shown in FIG. 5 as seen from the ink discharge surface, and FIG. 6B is a cross-sectional view of a peripheral portion of each head chip;

FIGS. 7A and 7B are cross-sectional views showing a state where the ink discharge surface of the line head shown in FIG. 4 is being cleaned, as seen from the side surface;

FIG. 8 is a side view of a cleaning device of the inkjet printer as the liquid discharge apparatus according to the embodiment (first embodiment) of the invention;

FIGS. 9A and 9B are side views of a peripheral portion of a cleaning belt of the cleaning device shown in FIG. 8;

FIG. 10 is a perspective view of a peripheral portion of an ink suction device of the inkjet printer shown in FIG. 8;

FIG. 11 is a partial cross-sectional view of the ink suction device shown in FIG. 10;

FIG. 12 is a flowchart illustrating a method of controlling the inkjet printer as the liquid discharge apparatus according to the embodiment (first embodiment) of the invention;

FIG. 13 is a schematic diagram of an ink path of an inkjet printer as a liquid discharge apparatus according to an embodiment (second embodiment) of the invention; and

FIGS. 14A and 14B are cross-sectional views showing a state where a line head is being cleaned by a rubber blade method in the related art, as seen from the side surface.

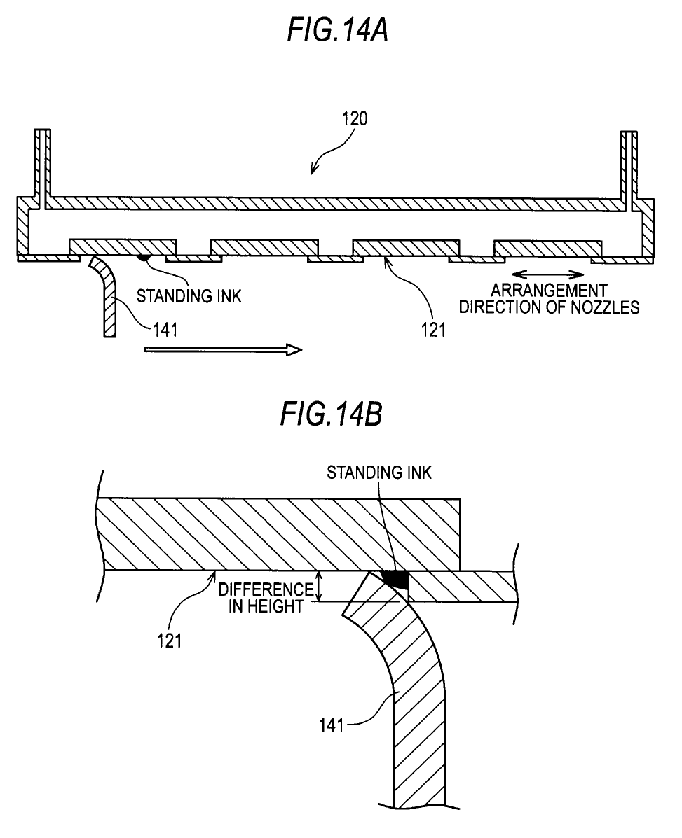

### DESCRIPTION OF THE PREFERRED EMBODIMENTS

Embodiments of the invention will be described below with reference to the drawings.

Here, a liquid discharge apparatus of an embodiment of the invention is inkjet printers 10 and 70, which discharge ink as liquid, in the following embodiments. Further, each of the inkjet printers 10 and 70 is a line inkjet printer that includes a line head 20 (which corresponds to a liquid discharge head in the embodiment of the invention) corresponding to a printing width (for example, A4 size). Furthermore, a nozzle array 32a, where a plurality of nozzles 32 for discharging ink is arranged in one direction at a predetermined pitch over the length of a printable maximum-size recording sheet in a sheet width direction, is formed at the line head 20. A portion where the nozzle array 32a is formed forms an ink discharge surface 21. In addition, the inkjet printers 10 and 70 manage color printing, and include a nozzle array 32a for each of ink colors, such as yellow (Y), magenta (M), cyan (C), and black (K). Meanwhile, the description will be made in the following order.

1. First embodiment (inkjet printer 10: an embodiment that does not reuse waste ink)

2. Second embodiment (inkjet printer 70: an embodiment that reuses waste ink)

### First Embodiment

### Configuration Example of Liquid Discharge Apparatus

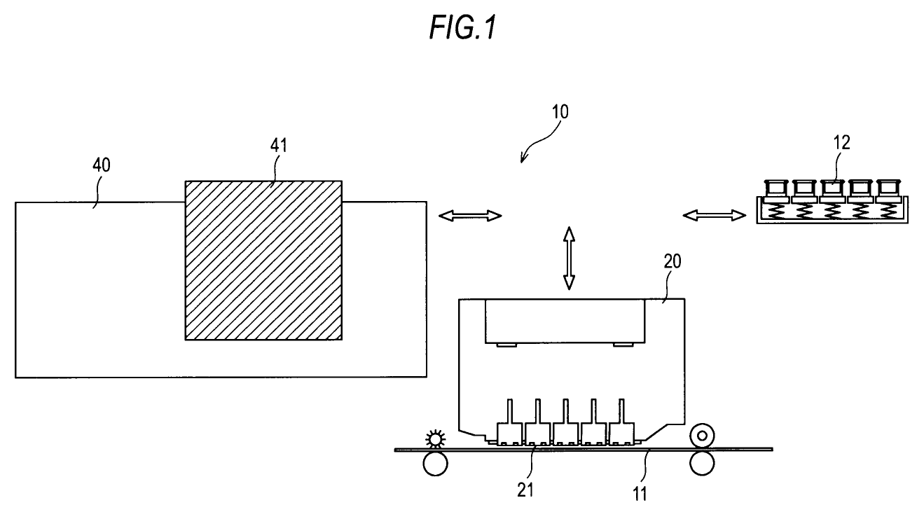

FIG. 1 is a front view showing the entire configuration of an inkjet printer 10 as a liquid discharge apparatus according to an embodiment (first embodiment) of the invention, and shows the state of the inkjet printer during printing.

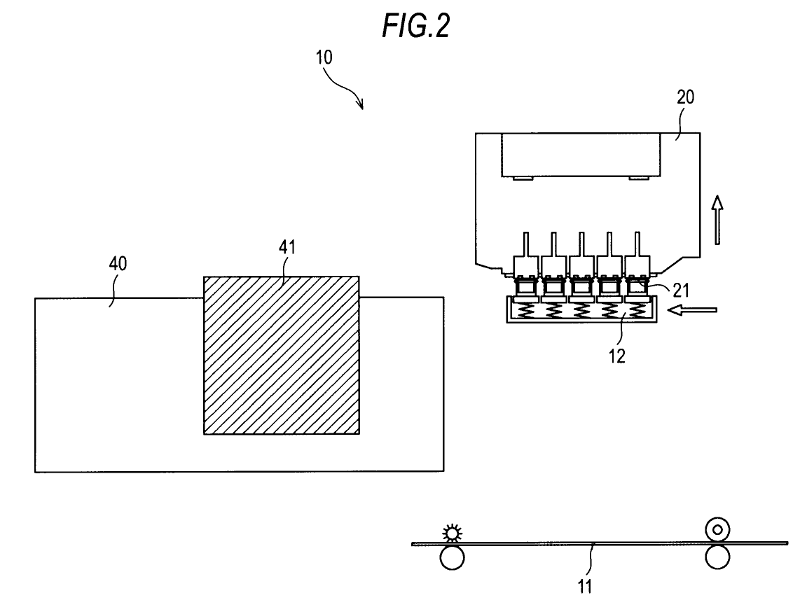

FIG. 2 is a front view showing the entire configuration of the inkjet printer 10 as the liquid discharge apparatus according to the embodiment (first embodiment) of the invention, and shows the state of the inkjet printer during standby.

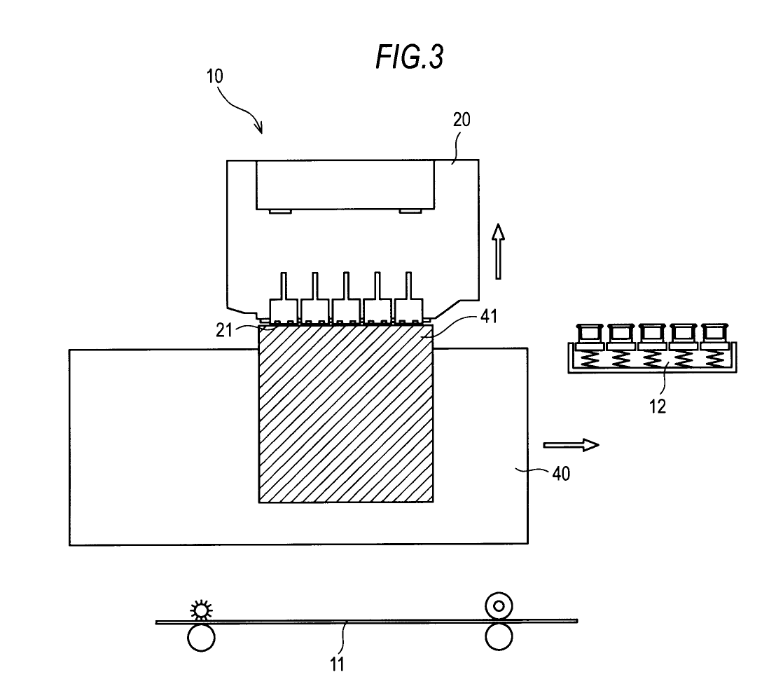

FIG. 3 is a front view showing the entire configuration of the inkjet printer 10 as the liquid discharge apparatus according to the embodiment (first embodiment) of the invention, and shows the state of the inkjet printer during cleaning.

As shown in FIGS. 1 to 3, the inkjet printer 10 includes a printing table 11 that substantially horizontally supports a recording sheet conveyed from a sheet feed unit (not shown), a line head 20 that forms an image on the recording sheet by discharging ink from an ink discharge surface 21 onto the recording sheet placed on the printing table 11, a head cap 12 that protects the ink discharge surface 21 of the line head 20, and a cleaning device 40 that includes a cleaning belt 41 for cleaning the ink discharge surface 21 of the line head 20.

Further, the inkjet printer 10 includes a lifting unit that lifts and lowers the line head 20 along a vertical arrow (see FIG. 1). The lifting unit may be formed of, for example, a piston, a cam, a belt, a gear to be rotationally driven, or a combination thereof. Furthermore, the line head 20 is lifted and lowered between a printing position (a position shown in FIG. 1) and a standby position (a position shown in FIG. 2) or a cleaning position (a position shown in FIG. 3) by the lifting unit. At the printing position, the ink discharge surface 21 is lowered directly above the printing table 11 by the lifting unit and an image is formed on the recording sheet. At the standby position, the line head is lifted so that the line head ink discharge surface 21 is covered with the head cap 12. The ink discharge surface 21 may be cleaned at the cleaning position. Meanwhile, the recording sheet is fed onto the printing table 11 from the sheet feed unit (not shown) and is supported substantially horizontally. Further, the recording sheet on which printing has been performed by the line head 20 is discharged to a paper tray (not shown).

In addition, the inkjet printer 10 includes a moving unit that moves the head cap 12 or the cleaning device 40 along a horizontal arrow (see FIG. 1). The moving unit may be formed of, for example, a piston, a cam, a belt, a gear to be rotationally driven, or a combination thereof. The head cap 12 is moved to enter a space formed on the printing table 11 from the right side to the left side and is positioned directly below the ink discharge surface 21 when the line head 20 is lifted and positioned at the standby position (the position shown in FIG. 2). Further, the ink discharge surface 21 is covered with the head cap 12 in a standby state where printing is not performed. Accordingly, the head cap 12 prevents ink from being dried and prevents dust or paper powder from being attached to the ink discharge surface in the standby state, so that the clogging of nozzles 32 (not shown) is prevented. Meanwhile, in order to improve sealability between the head cap and the ink discharge surface 21, the head cap 12 is formed by arranging rubber caps, which are provided for each of the ink colors, in accordance with the arrangement of the nozzles 32 corresponding to each of the ink colors.

Further, the cleaning device 40 includes an endless cleaning belt 41 (which corresponds to a liquid adsorbent in the invention) that is made of a porous foam or the like. Furthermore, while the line head 20 is positioned at the cleaning position (the position shown in FIG. 3), the cleaning device enters a space formed on the printing table 11 from the left side to the right side and is moved in order to perform cleaning so that the ink discharge surface 21 and the cleaning belt 41 face each other. After that, the cleaning device wipes off waste ink or the like attached to the ink discharge surface 21 by making the cleaning belt 41 come into contact with the ink discharge surface 21 and moving the cleaning belt in a direction perpendicular to the plane of FIG. 3, and adsorbs the waste ink or the like. Meanwhile, the cleaning belt 41 may be made of nonwoven fabric, condensed chemical fiber, or the like other than porous foam.

### [Configuration Example of Liquid Discharge Head]

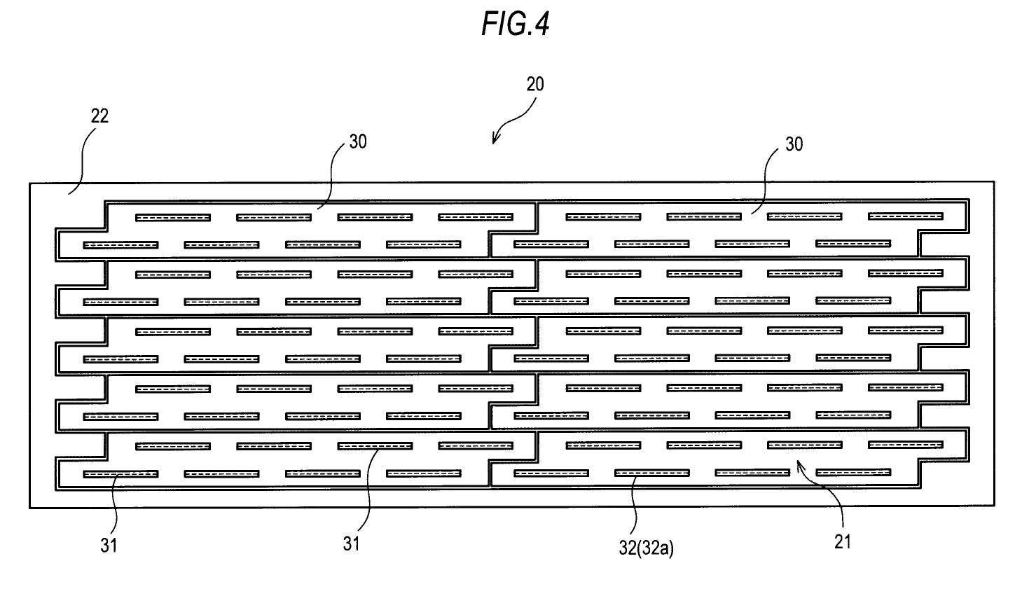

FIG. 4 is a plan view of the line head 20 of the inkjet printer 10 shown in FIGS. 1 to 3, and is a view as seen from the ink discharge surface 21.

As shown in FIG. 4, the line head 20 includes a head frame 22 and a plurality of head modules 30 that is held by the head frame 22. Specifically, two head modules 30 are connected in series in the longitudinal direction of the head frame 22 (the sheet width direction), and are inserted into the head frame 22. Further, the two head modules 30 cover the width of a printable maximum-size recording sheet (for example, the width of an A4 sheet), and print the recording sheet with one color. Furthermore, five lines, each of which is formed by the two head modules 30 connected in series, (total ten head modules) are provided parallel to each other, and form a full-color image by discharging Y (yellow), M (magenta), C (cyan), and K (black) inks, respectively.

In addition, each of the head modules 30 is provided with a plurality of head chips 31. Specifically, eight head chips 31 are disposed in zigzags in the form of a 4-by-2 matrix in each of the head modules 30. Further, in each of the head chips 31, a plurality of nozzles 32 for discharging ink is arranged in one direction so as to form a nozzle array 32a. For this reason, nozzle arrays 32a are disposed in two lines in each of the head modules 30 so as to be parallel to each other the head modules 30 and nozzle arrays are disposed in ten lines so as to be parallel in the entire line head 20. A portion of the line head where the nozzle arrays 32a are formed (a surface of the line head where the nozzle arrays 32a are formed) forms the ink discharge surface 21. Meanwhile, a distance between the nozzles 32 is the same in all of the head chips that are adjacent to each other in zigzags.

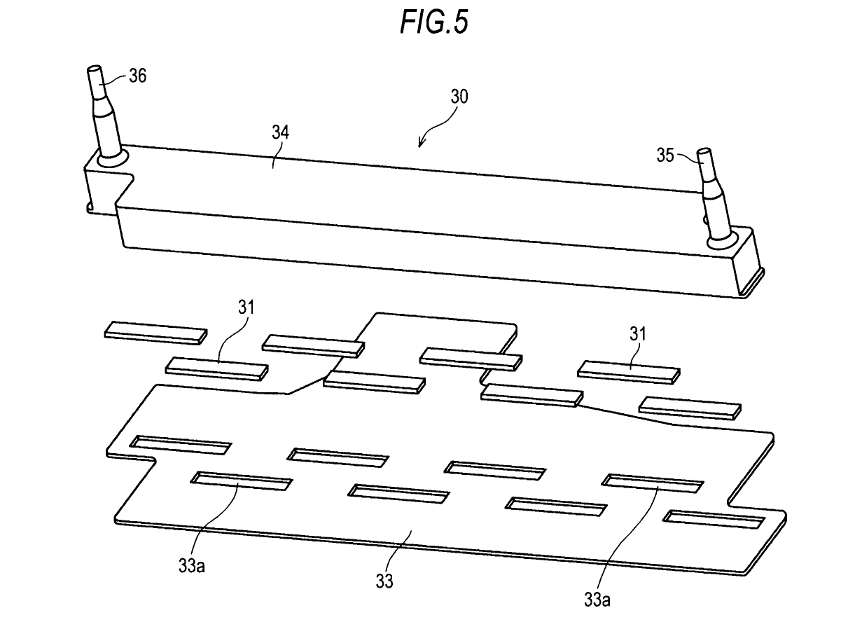

FIG. 5 is an exploded perspective view of each head module 30 of the line head 20 shown in FIG. 4.

As shown in FIG. 5, the head module 30 includes eight head chips 31, a flexible sheet 33 on which the respective head chips 31 are disposed, and an ink tank 34. Meanwhile, the ink discharge surface 21 shown in FIG. 4 is the lower surface of the flexible sheet 33 shown in FIG. 5.

Here, the flexible sheet 33 is a flexible wiring board that electrically connects the head chip 31 to a control board (not shown), and is made of polyimide and has a thickness of about 50 μm. Further, openings 33a are formed in zigzags at the flexible sheet 33. Furthermore, each of the head chips 31 is connected to the flexible sheet 33 so that all the nozzles 32 (see FIG. 4) are positioned in the opening 33a and the head chip 31 closes the opening 33a.

Moreover, the ink tank 34 is bonded onto the flexible sheet 33 so as to cover the respective head chips 31. The ink tank 34 forms a common flow passage through which ink is supplied to the respective head chips 31. Further, the ink tank includes an ink supply port 35 (which corresponds to a liquid supply port in the invention) which is connected to an ink cartridge 13 (not shown) and through which ink is supplied to the common flow passage, and an ink discharge port 36 through which ink in the common flow passage is discharged. For this reason, the ink stored in the cartridge 13 flows in the common flow passage of the ink tank 34 through the ink supply port 35, and is supplied to the respective head chips 31. Meanwhile, when the head module 30 is inserted into the head frame 22 (see FIG. 4), a portion of the flexible sheet 33 protruding from the head module 30 is bent along the side surface of the ink tank 34.

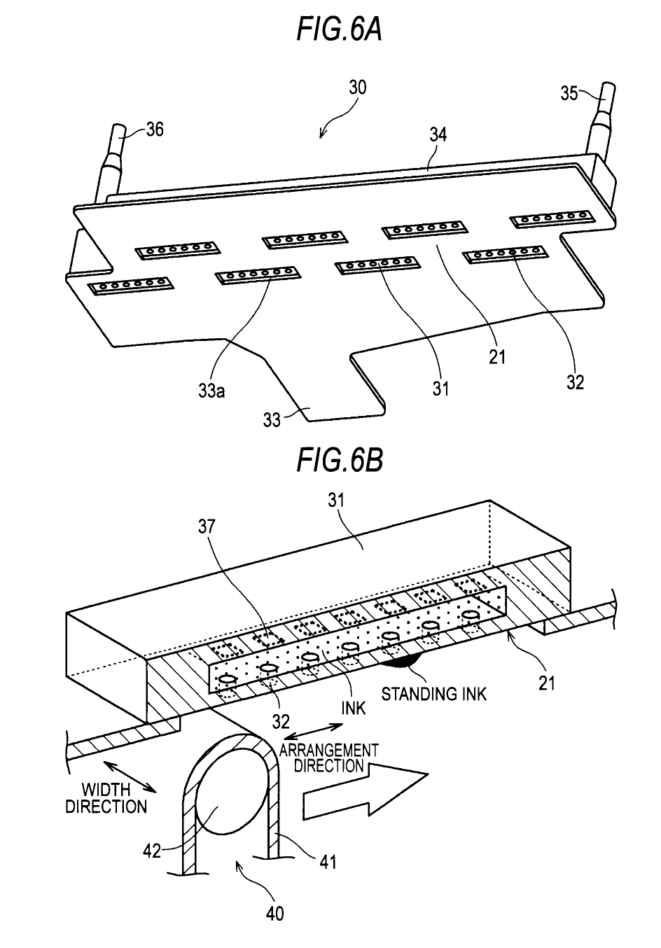

FIG. 6A is a perspective view of the head module 30 shown in FIG. 5 as seen from the ink discharge surface 21, and FIG. 6B is a cross-sectional view of a peripheral portion of each head chip 31.

As shown in FIG. 6A, the head module 30 is formed by disposing eight head chips 31 in zigzags in an internal space between the flexible sheet 33 and the ink tank 34. Further, all the nozzles 32 of each of the head chips 31 are positioned in the opening 33a of the flexible sheet 33. For this reason, the ink discharge surface 21 is formed of the surface of the flexible sheet 33 except for the openings 33a and surfaces of the head chips 31 positioned in the openings 33a.

Furthermore, as shown in FIG. 6B, the head chip 31 includes a plurality of heating resistors 37 that is arranged at positions facing the respective nozzles 32, and a space between each of the nozzles 32 and each of the heating resistors 37 forms a liquid chamber for ink. Further, when ink is supplied from the ink supply port 35 (see FIG. 6A), not only spaces around the head chips 31 but also the liquid chambers of the head chips 31 are filled with ink.

Here, when pulse current flows in the heating resistor 37 through the flexible sheet 33 (see FIG. 6A) in a short time (for example, 1 to 3 microseconds) by a command sent from the control board (not shown), the heating resistor 37 is rapidly heated. For this reason, bubbles of ink are generated (ink is boiled) at a portion coming into contact with the heating resistor 37, and ink having a predetermined volume is pushed by the expansion of the bubbles. As a result, this becomes discharge pressure, and ink having the same volume as the volume of the pushed ink is discharged from the nozzle 32.

As described above, the head chip 31 discharges ink from the nozzles 32 by heating the heating resistor 37, and forms an image on the recording sheet that is fed directly below the nozzles 32. For this reason, while ink is repeatedly discharged, standing ink may be generated on the ink discharge surface 21 or dirt or foreign materials may be attached to the ink discharge surface. Further, if this state is left out, the discharge of ink from the nozzle 32 is hindered, which causes discharge failure, such as nondischarge or incomplete discharge.

Furthermore, standing ink corresponding to different colors is also attached to the ink discharge surface 21 in the line head 20 (see FIG. 4) that manages full color. For this reason, the standing ink, which has a color different from the colors of existing ink stored in the head module 30, may flow back from the nozzles 32. In addition, the color of the standing ink is mixed to the colors of the existing ink, so that mixed color ink is discharged. Therefore, the deterioration of image quality, such as change in concentration, deviation in hue, and stripe unevenness, is caused.

Accordingly, the cleaning device 40 shown in FIG. 6B is provided to wipe off the standing ink and the like from the ink discharge surface 21. The cleaning device 40 includes an endless cleaning belt 41 and installation rollers 42 where the cleaning belt 41 is rotatably installed. The cleaning belt 41 is provided so that an angle (90° in this embodiment) is formed between the width direction of the cleaning belt and the arrangement direction of the nozzles 32. Further, the cleaning belt 41, which is positioned on the peripheral surface of the installation roller 42, comes into contact with the ink discharge surface 21. Furthermore, the width of the cleaning belt 41 is slightly larger than a distance between both outer nozzle arrays 32a of the ten nozzle arrays that are disposed in parallel in the transverse direction of the line head 20 shown in FIG. 4. Accordingly, as shown in FIG. 3, the cleaning belt 41 has a width capable of covering the entire width of the ink discharge surface 21.

The cleaning belt 41 of the cleaning device 40 is moved in the arrangement direction of the nozzles 32 by a moving unit that moves the cleaning belt 41 along an arrow that is obliquely inclined toward the right upper side in FIG. 6B. Accordingly, the cleaning belt wipes off the standing ink and the like that are attached to the ink discharge surface 21. Meanwhile, the cleaning belt 41 is rotatably installed around the installation rollers 42, but is not rotated while being moved.

Here, the ink discharge surface 21 of the line inkjet printer including the line head 20 (see FIG. 4) is very much larger than that of a serial inkjet printer that performs printing while moving a head. For this reason, a cleaning range is large and the amount of ink to be sucked is increased in the case of the line inkjet printer. Therefore, there is a problem in the reverse transfer of ink to the ink discharge surface 21. Specifically, although standing ink and the like of the ink discharge surface 21 are adsorbed well at a cleaning start position, adsorbability is decreased as a position approaches a cleaning end position. As a result, a portion of the ink discharge surface 21, which is to be cleaned later, is typically contaminated. Accordingly, there is a high possibility that positions where the discharge failure of ink is caused may be concentrated on the portion of the ink discharge surface to be cleaned later. In this embodiment, a belt-shaped porous foam (cleaning belt 41) of which the ink adsorption capacity is larger than the ink adsorption capacity of a roller-shaped porous foam (cleaning roller) is used in order to prevent this problem. Meanwhile, since the adsorbed ink is sucked so that the adsorbability is restored, the cleaning roller may be used without limitation on the cleaning belt 41.

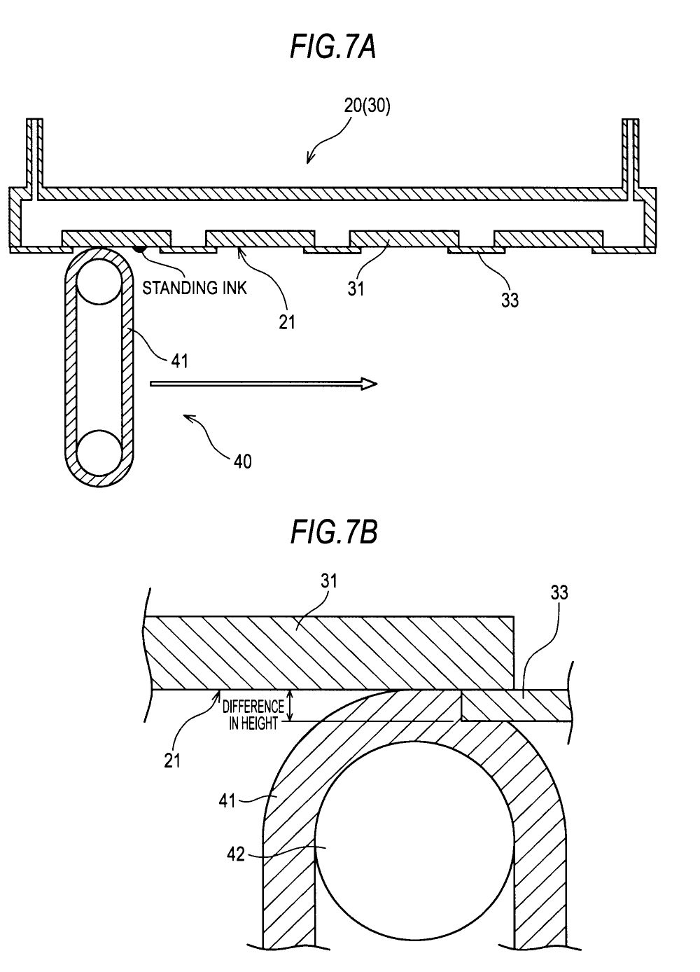

FIGS. 7A and 7B are cross-sectional views showing a state where the ink discharge surface 21 of the line head 20 shown in FIG. 4 is being cleaned, as seen from the side surface.

As shown in FIG. 7A, the cleaning belt 41 slides on the ink discharge surface 21 in a direction of an arrow. Accordingly, standing ink, dirt, foreign materials, and the like, which are attached to the ink discharge surface 21, are wiped out by the movement of the cleaning belt 41 like a wiper.

Here, as shown in FIG. 7B, a stepped portion (a stepped portion having a difference in height of about 50 μm in this embodiment) between the head chip 31 and the flexible sheet 33 is formed on the ink discharge surface 21. However, the cleaning belt 41 is made of an open cell porous foam that has flexibility, water adsorbability, and air permeability. Accordingly, a portion positioned on the peripheral surface of the installation rollers 42 follows the stepped portion. For this reason, a gap is not formed at a corner of the stepped portion, and it may be possible to almost completely adsorb residual ink and the like existing at the corner of the stepped portion by a synergistic effect of this and a capillary force of a pore (cell) formed in the porous foam.

Further, even when the number of head modules 30, which are connected in series, is increased in order to increase the width of a printable recording sheet (for example, in order to increase the width of an A4 sheet to the width of an A3 sheet), it is not necessary to change the width of the cleaning belt 41 of the cleaning device 40 of this embodiment. In other words, even though the width of the recording sheet is increased, it may be possible to clean the line head by increasing the moving distance of the cleaning belt without changing the width of the cleaning belt 41. For this reason, it may be possible to avoid the increase in the size of the cleaning device 40.

Furthermore, the endless cleaning belt 41 may be rotated by a rotational drive unit that rotationally drives the installation roller 42. For this reason, a contact portion of the cleaning belt 41, which comes into contact with the ink discharge surface 21 and is contaminated by the wiping-off, may be changed by the rotational drive of the installation roller 42. Accordingly, it may be possible to use a fresh portion of the cleaning belt, which is not contaminated, at the time of the next cleaning.

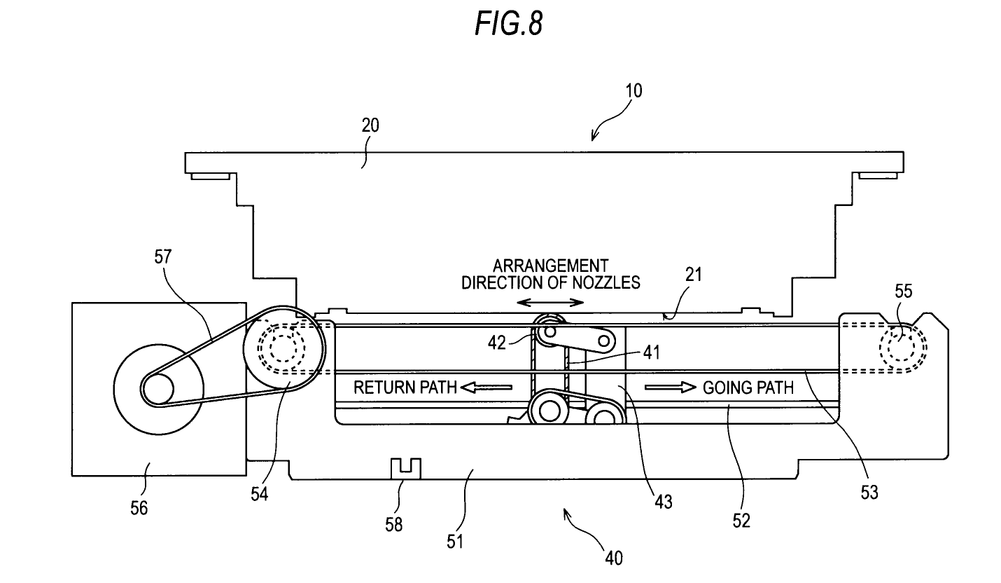

FIG. 8 is a side view of the cleaning device 40 of the inkjet printer 10 as the liquid discharge apparatus according to the embodiment (first embodiment) of the invention.

As shown in FIG. 8, the endless cleaning belt 41, which cleans the ink discharge surface 21 of the line head 20, is installed so as to be rotated by the installation rollers 42. Further, the installation rollers 42 are supported by a belt frame 43 (which corresponds to a support frame in the invention). Furthermore, the cleaning belt 41 is provided in the belt frame 43 so that an angle (90° in this embodiment) is formed between the width direction of the cleaning belt and the arrangement direction of the nozzles. In addition, the belt frame 43 is reciprocated in the arrangement direction of the nozzles by a moving unit that moves the belt frame 43 along a horizontal arrow shown in FIG. 8. Meanwhile, in FIG. 8, a right direction corresponds to a going path and a left direction corresponds to a return path. However, a right direction may correspond to a return path and a left direction may correspond to a going path.

The moving unit for the belt frame 43 may be formed of, for example, a piston, a cam, a belt, a gear to be rotationally driven, or a combination thereof. Further, in this embodiment, the moving unit for the belt frame 43 includes a belt driving motor 56, a movement transmitting belt 57, a guide shaft 52, a moving drive belt 53, a moving drive pulley 54, and a tension pulley 55 that are provided in a base frame 51. Meanwhile, since it is preferable that the cleaning belt 41 be moved relative to the ink discharge surface 21, there may be provided a moving unit that moves the line head 20.

Here, the guide shaft 52, which is provided in the longitudinal direction of the base frame 51, is inserted into the belt frame 43 so that the belt frame is movable. Further, the moving drive belt 53 is caught by a part of the belt frame 43. Furthermore, the moving drive belt 53 is installed parallel to the guide shaft 52 between the moving drive pulley 54 that is provided at one end of the base frame 51 and the tension pulley 55 that is provided at the other end of the base frame.

The moving drive pulley 54 is rotationally driven through the movement transmitting belt 57 by a belt driving motor 56. For this reason, when the belt driving motor 56 is driven in a normal or reverse direction, the moving drive pulley 54 is also rotated in the normal or reverse direction and may rotate the moving drive belt 53. Accordingly, as the belt driving motor 56 is driven in the normal or reverse direction, the belt frame 43 is reciprocated along the guide shaft 52 at a speed that corresponds to the rotation speed of the moving drive belt 53. Further, cleaning is completed by one reciprocating motion, and a home position (reference position) of the belt frame 43 is detected by a position sensor 58 that is provided on the base frame 51.

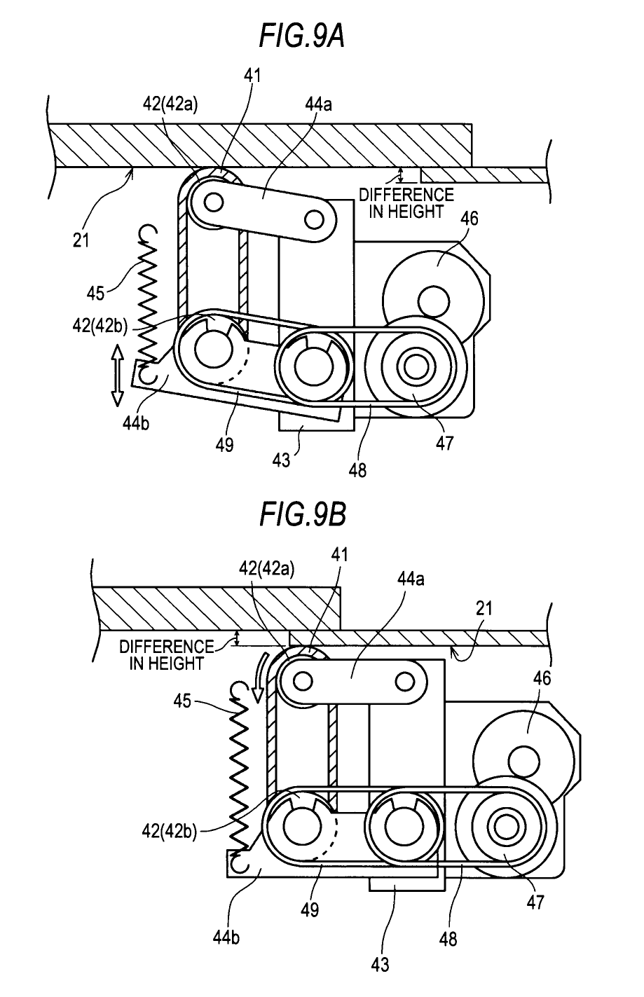

FIGS. 9A and 9B are side views of a peripheral portion of the cleaning belt 41 of the cleaning device 40 shown in FIG. 8.

As shown in FIGS. 9A and 9B, the cleaning belt 41 is formed in an endless shape, and is installed so that an appropriate tension is applied to the cleaning belt by a pair of installation rollers 42 (installation rollers 42a and 42b). Further, the cleaning belt 41 is made of an open cell porous foam that has flexibility, water adsorbability, and air permeability. For this reason, it may be possible to adsorb standing ink, which is attached to the ink discharge surface 21, by the cleaning belt 41.

Moreover, the installation rollers 42 are supported by the belt frame 43 through upper and lower links 44a and 44b, so that a four-node link mechanism is formed. For this reason, the cleaning belt 41, which is installed around the installation rollers 42, may be moved up and down parallel to the belt frame 43. Furthermore, the lower link 44b is pushed upward by a push-up spring 45 so that a portion of the cleaning belt 41, which is positioned on the peripheral surface of the upper installation roller 42a, comes into contact with the ink discharge surface 21 at a predetermined pressure. Accordingly, even though stepped portions are formed on the ink discharge surface 21, the lower link 44b is moved up and down along a vertical arrow shown in FIG. 9A. As a result, since the installation rollers 42 are also moved up and down, the cleaning belt 41 follows the stepped portions of the ink discharge surface 21.

In addition, the cleaning belt 41 may be rotated along a counterclockwise arrow shown in FIG. 9B by a rotational drive unit that rotationally drives the lower installation roller 42b. The rotational drive unit may be formed of, for example, a piston, a cam, a belt, a gear to be rotationally driven, or a combination thereof. Further, in this embodiment, the rotational drive unit for the installation roller 42b includes a belt rotating motor 46, a rotational drive pulley 47, a rotation transmitting belt 48, a rotational drive belt 49, and the like.

Here, the installation roller 42b is rotationally driven by the belt rotating motor 46. That is, when the belt rotating motor 46 is rotationally driven, the rotational drive pulley 47 is rotated in accordance with the rotational drive of the belt rotating motor. Further, the torque of the rotational drive pulley is transmitted to the installation roller 42b by the rotation transmitting belt 48 and the rotational drive belt 49. Accordingly, since the cleaning belt 41 is rotated with the drive of the belt rotating motor 46, it may be possible to rotate the cleaning belt 41 at a desired timing by a desired angle by controlling the belt rotating motor 46. Meanwhile, the cleaning belt 41 may be rotated while coming into contact with the ink discharge surface 21. However, in this embodiment, the cleaning belt is rotated while being separated from the ink discharge surface 21.

As described above, in the inkjet printer 10 according to this embodiment, the cleaning belt 41 comes into contact with the ink discharge surface 21 at a predetermined pressure and is moved in the arrangement direction of the nozzles (see FIG. 8). For this reason, it may be possible to clean the ink discharge surface by wiping off the standing ink and the like from the ink discharge surface 21. Further, if the cleaning belt 41 is rotated, the contact portion of the cleaning belt, which comes into contact with the ink discharge surface 21 and is contaminated by the wiping-off, may be changed. Accordingly, if the cleaning belt is rotated at an appropriate timing, it may be possible to clean the ink discharge surface again by using a fresh portion of the cleaning belt.

### [Configuration Example of Ink Suction Device]

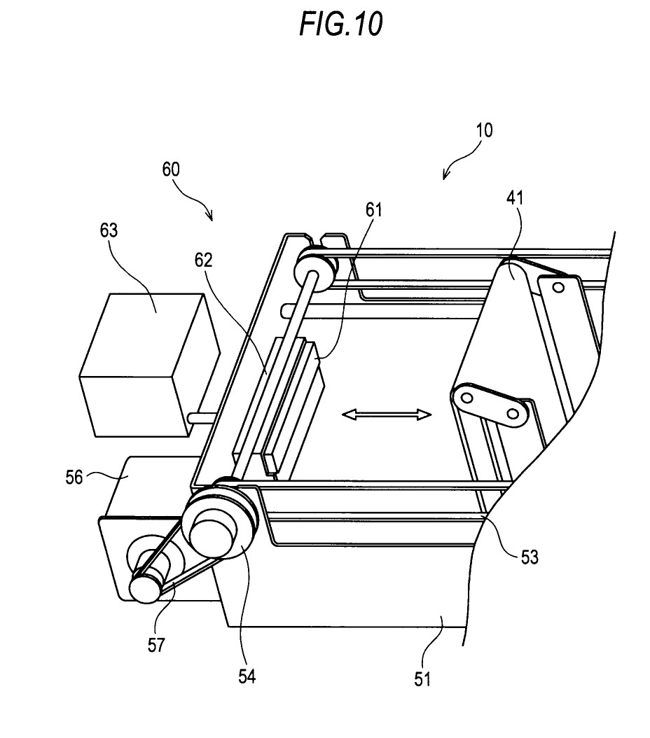

FIG. 10 is a perspective view of a peripheral portion of an ink suction device 60 of the inkjet printer 10 shown in FIG. 8.

As shown in FIG. 10, the inkjet printer 10 according to this embodiment includes an ink suction device 60. The ink suction device 60 is provided at the end of the base frame 51 in the longitudinal direction of the base frame (on the side corresponding to the moving drive pulley 54 in this embodiment) so as to suck waste ink and the like that are adsorbed in the cleaning belt 41 by the wiping-off. Further, the ink suction device includes an ink collecting body 61 (which corresponds to a liquid collecting body in the invention) that is made of a porous foam or the like (an open cell foam, which has water adsorbability and air permeability, in this embodiment). Meanwhile, the ink collecting body 61 is formed in the shape of a block, which has substantially the same width as the width of the cleaning belt 41, so as to efficiently adsorb waste ink or the like that is adsorbed in the cleaning belt 41.

Further, the ink suction device 60 includes a collecting body case 62 that receives the ink collecting body 61. The collecting body case 62 is a resin molding, and functions to make the ink collecting body 61 be easily fixed to the base frame 51 and to prevent waste ink, which is collected in the collecting body case 62, from being leaked to the outside. Furthermore, a waste liquid port 62a (not shown) is formed at the collecting body case 62, and a suction pump 63 (which serves as a liquid suction unit in the invention), which sucks waste ink and the like collected in the ink collecting body 61, is connected to the waste liquid port 62a.

Here, the cleaning belt 41, which wipes off standing ink and the like from the ink discharge surface 21 (see FIG. 8), is reciprocated in a direction of an arrow through the movement transmitting belt 57, the moving drive pulley 54, and the moving drive belt 53 by the rotational drive of the belt driving motor 56. When the cleaning belt 41 is moved toward the moving drive pulley 54, the cleaning belt 41 comes into contact with the ink collecting body 61. Accordingly, it may be possible to suck waste ink and the like, which are adsorbed in the cleaning belt 41, through the ink collecting body 61 by the suction pump 63.

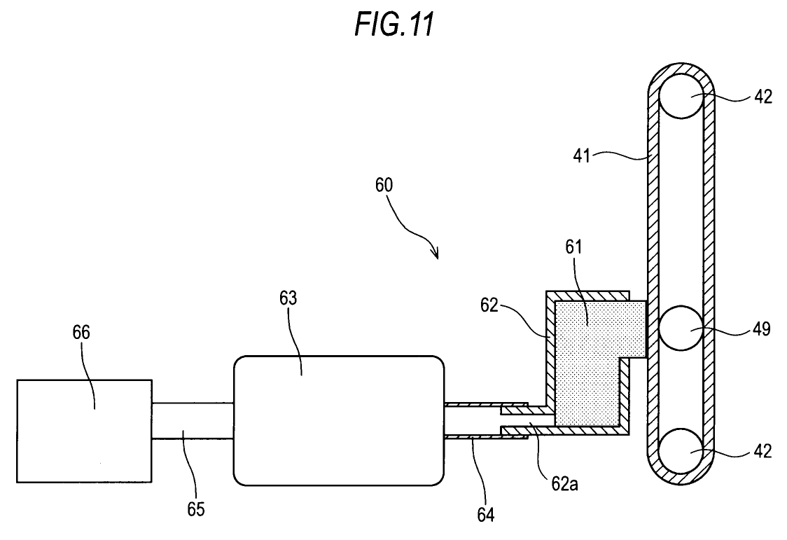

FIG. 11 is a partial cross-sectional view of the ink suction device 60 shown in FIG. 10.

As shown in FIG. 11, the cleaning belt 41 is installed so that an appropriate tension is applied to the cleaning belt by the pair of (upper and lower) installation rollers 42. Further, an intermediate roller 49 is provided at a contact position where the cleaning belt comes into contact with the ink collecting body 61. Accordingly, when coming into contact with the ink collecting body 61, the cleaning belt 41 is supported by the intermediate roller 49 and the ink collecting body 61 appropriately comes into press contact with the cleaning belt 41 made of a porous foam. As a result, waste ink and the like, which are adsorbed in the cleaning belt 41 by the wiping-off of the standing ink and the like, are collected in the ink collecting body 61.

Here, as for foams that form the cleaning belt 41 and the ink collecting body 61, it is preferable that the water adsorbability of the ink collecting body 61 is higher than that of the cleaning belt 41. Accordingly, it may be possible to collect waste ink smoothly, which is adsorbed in the cleaning belt 41, by the ink collecting body 61. Meanwhile, since waste ink and the like are sucked by the suction pump 63, it is not necessary that the water adsorbability of the ink collecting body 61 is necessarily high.

Further, waste ink and the like, which are collected in the ink collecting body 61, may be removed through the waste liquid port 62a of the collecting body case 62. Further, the suction pump 63 is connected to the waste liquid port 62a through a connecting tube 64, and a waste ink tank 66 is connected to the discharge side of the suction pump 63 through a connecting tube 65. Accordingly, when the suction pump 63 is operated, the waste ink and the like, which are collected in the ink collecting body 61, are sucked by negative pressure and discharged to the waste ink tank 66. As a result, the ink adsorbability of the cleaning belt 41 is typically maintained high, so that the cleaning performance of the ink discharge surface 21 (see FIG. 8) does not deteriorate.

As described above, the ink suction device 60 may actively suck the waste ink and the like, which are collected in the ink collecting body 61, from the cleaning belt 41 by the suction pump 63, and may discharge the waste ink and the like to the waste ink tank 66. Accordingly, it may be possible to remove the saturation of the waste ink, which is impregnated and accumulated in the cleaning belt 41 or the ink collecting body 61, and to prevent the deterioration of the wiping performance of the cleaning belt 41.

In particular, if the number of nozzles 32 arranged in the longitudinal direction is large as in the line head 20 shown in FIG. 4, the amount of waste ink and the like to be wiped off from the ink discharge surface 21 is large. For this reason, the suction of the waste ink and the like, which is performed by the suction pump 63 shown in FIG. 11, is effective in preventing the contamination of the ink discharge surface 21. Further, the suction of the waste ink and the like is also effective for the restoration when the number of prints is large and when the nozzles 32 are dried due to irregular use while the line head 20 is not used over a long period.

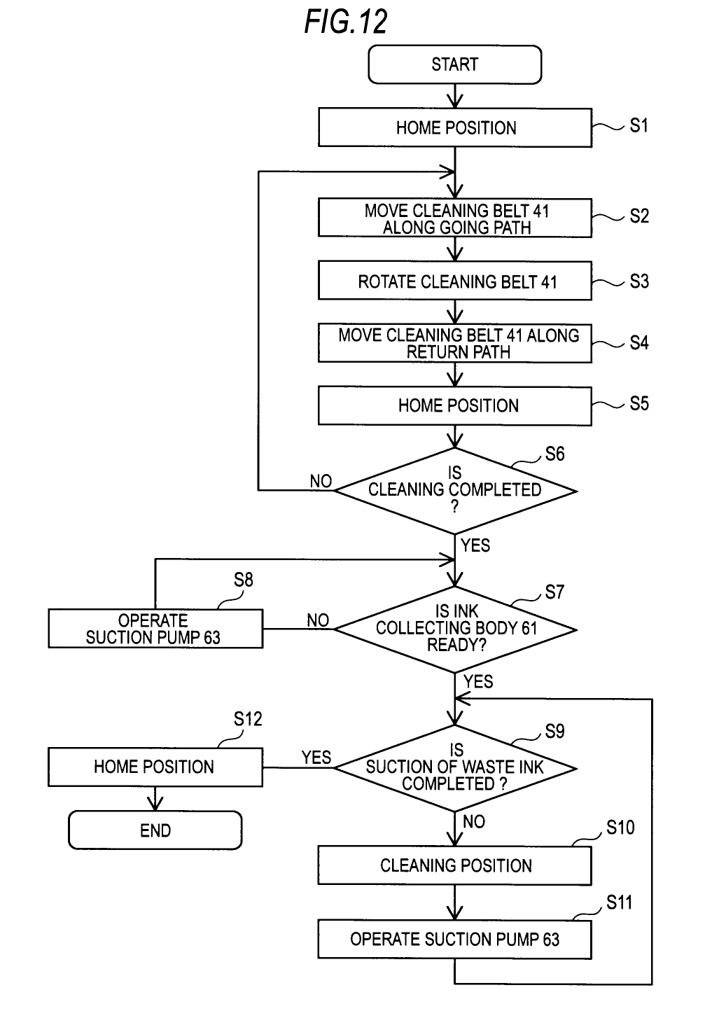

FIG. 12 is a flowchart illustrating a method of controlling the inkjet printer 10 (see FIG. 10) as the liquid discharge apparatus according to the embodiment (first embodiment) of the invention.

The inkjet printer 10 according to this embodiment automatically executes a cleaning/maintenance program after a series of printing processes is completed. Further, after the start of the program, the cleaning belt 41 is set to the home position in the first Step S1. Specifically, the cleaning device 40 enters from a retract position to face the line head 20 as shown in FIG. 3 so that the cleaning belt 41 comes into contact with the ink discharge surface 21 near the moving drive pulley 54 (see FIG. 8). Meanwhile, the home position is detected by the position sensor 58 (see FIG. 8).

In the next Step S2, the cleaning belt 41 is moved along the going path. Specifically, the cleaning belt 41 is horizontally moved along the ink discharge surface 21 in a direction of a rightward arrow shown in FIG. 8. In this case, the number of pulses, which rotationally drive the belt driving motor 56, is counted from the home position as reference. Further, while the cleaning belt 41 is moved, the installation rollers 42 are not rotationally driven due to the stop control of the belt rotating motor 46 shown in FIGS. 9A and 9B, so that the cleaning belt 41 is not rotated. Accordingly, the ink discharge surface 21 is rubbed by the cleaning belt like a wiper, so that the ink contamination, dirt, foreign materials and the like are sequentially wiped off from the ink discharge surface 21.

Here, a stepped portion having the difference in height is formed on the ink discharge surface 21 as shown in FIGS. 9A and 9B. However, a portion of the cleaning belt 41, which is positioned on the peripheral surface of the installation roller 42a and is made of a porous foam having flexibility, water adsorbability, and air permeability, follows the stepped portion. For this reason, a gap is not formed at a corner of the stepped portion, and it may be possible to almost completely wipe off residual ink and the like existing at the corner of the stepped portion by a synergistic effect of this and a capillary force of a pore (cell) formed in the porous foam.

Further, if the cleaning belt 41 is moved up to the end position (the vicinity of the tension pulley 55 shown in FIG. 8), the cleaning belt 41 is rotated in Step S3 so that a wiping portion of the cleaning belt wiping off the ink discharge surface 21 is changed. Accordingly, there is prevented the deterioration of the cleaning performance that is caused when cleaning continues to be performed by the same portion of the cleaning belt. In this case, through the counting of the number of pulses that rotationally drive the belt driving motor 56 (see FIG. 8) (whether the number of pulses reaches a predetermined number of pulses), it is determined whether the cleaning belt reaches the end position. The cleaning belt 41 is rotated by the belt rotating motor 46. Meanwhile, when the cleaning belt 41 is rotated, the contact between the ink discharge surface 21 and the cleaning belt is temporarily released.

Subsequently, the cleaning belt 41 is moved along the return path (is moved along a leftward arrow shown in FIG. 8) in Step S4, so as to perform the same cleaning operation (the wiping off of the ink discharge surface 21 shown in FIG. 8) as the movement of the cleaning belt along the going path in Step S2. Further, in Step S5, the cleaning belt 41 is returned to the home position. Accordingly, during the movement of the cleaning belt on the return path and the going path, the entire ink discharge surface 21 is uniformly wiped off by the cleaning belt 41, of which the wiping portion is changed, in one reciprocating motion that is performed through the home position, the end position, and the home position. Meanwhile, the home position is detected by the position sensor 58 (see FIG. 8).

If the cleaning belt 41 is returned to the home position as described above, it is determined in the next Step S6 whether the cleaning is completed. Specifically, there may also be considered a case where the ink discharge surface 21 is not sufficiently wiped off in one reciprocating motion of the cleaning belt 41. For this reason, it is determined whether to complete the cleaning, by providing a contamination sensor so as to detect whether residual ink exists, or by determining whether the number of reciprocating motions reaches a predetermined number of reciprocating motions. Further, if the cleaning is not completed, the cleaning operation of Steps S2 to S5 is repeated.

Here, if a process returns to Step S2 from Step S6, the cleaning belt 41 is rotated so that the wiping portion is changed. However, if the entire portion of the cleaning belt 41 has been come into contact with the ink discharge surface 21 once, there is no fresh portion. Meanwhile, the front and back surfaces of the cleaning belt come into contact with the air during the rotation of the cleaning belt 41, so that air permeability is improved and drying is facilitated. Accordingly, the water contained in the adsorbed ink is evaporated, and adsorbability is restored due to the evaporation of the water.

Meanwhile, if the cleaning is completed in Step S6, the process proceeds to Step S7 and it is determined whether the ink collecting body 61 is ready. Specifically, there is detected the amount of waste ink collected in the ink collecting body 61. Further, if it is determined that the amount of collected waste ink is larger than a predetermined amount (exceeds a predetermined value), the suction pump 63 is operated so as to suck the waste ink from the ink collecting body 61 in Step S8. Meanwhile, the sucked waste ink is discharged to the waste ink tank 66 (see FIG. 11).

Furthermore, if the ink collecting body 61 is ready (the amount of collected waste ink is smaller than a predetermined amount) in Step S7, the process proceeds to Step S9 and it is determined whether the suction of the waste ink adsorbed in the cleaning belt 41 is completed. Specifically, there is detected the amount of waste ink adsorbed in the cleaning belt 41. Further, if it is determined that the amount of adsorbed waste ink is larger than a predetermined amount (exceeds a predetermined value), the cleaning belt 41 is moved to the cleaning position in Step S10. As shown in FIG. 11, the cleaning position is a position where the cleaning belt 41 comes into contact with the ink collecting body 61.

In this case, the cleaning belt 41 is rotated by the belt rotating motor 46 shown in FIGS. 9A and 9B so that a portion (wiping portion) of the cleaning belt positioned on the peripheral surface of the installation roller 42a faces the ink collecting body 61 (see FIG. 11). For this reason, when the cleaning belt 41 is moved to the cleaning position, the wiping portion of the cleaning belt 41 comes into contact with the ink collecting body 61. As a result, the waste ink adsorbed in the cleaning belt 41 is collected in the ink collecting body 61 by a capillary force.

The suction pump 63 is operated so as to suck the waste ink from the ink collecting body 61 in the next Step S11. Accordingly, the waste ink adsorbed in the cleaning belt 41 is rapidly sucked through the ink collecting body 61, which comes into contact with the cleaning belt 41, by the capillary force of the ink collecting body 61 and the negative pressure of the suction pump 63. Then, in Step S9, it is determined again whether the suction of the waste ink adsorbed in the cleaning belt 41 is completed. Accordingly, the cleaning belt 41 is positioned at the cleaning position until adsorbability is restored, and the suction of the waste ink continues to be performed by the suction pump 63. Meanwhile, the sucked waste ink is discharged to the waste ink tank 66 (see FIG. 11).

Further, if the amount of adsorbed waste ink becomes smaller than a predetermined amount by the suction of the waste ink adsorbed in the cleaning belt 41, it is determined in Step S9 that the suction of the waste ink is completed. Furthermore, if the suction of the waste ink is completed, the process proceeds to Step S12 from Step S9 and the cleaning belt 41 is moved to the home position. In addition, as shown in FIG. 1 or 2, the cleaning device 40 is retracted from the line head 20 so that the cleaning/maintenance program is ended.

The inkjet printer 10 (see FIG. 10) is controlled in accordance with a flowchart shown in FIG. 12 and the cleaning/maintenance program is executed as described above, so that the waste ink adsorbed in the cleaning belt 41 is sucked by the suction pump 63. For this reason, the cleaning performance is restored without the replacement or wringing of the cleaning belt 41, so that the ink adsorbability of the cleaning belt 41 is maintained high. Accordingly, according to the inkjet printer 10 of this embodiment, it may be possible to wipe off the ink discharge surface 21 (see FIG. 8) without contamination that is caused by residual ink after the wiping off or the reverse transfer of ink.

Here, it may be possible to electrically control the operation of the suction pump 63 according to the state or purpose of the cleaning belt 41. For example, when the amount of waste ink adsorbed in the cleaning belt 41 is larger than a predetermined amount, the suction pump 63 may be operated so as to suck the waste ink regardless of the process flow of the flowchart shown in FIG. 12. Further, when the amount of waste ink collected in the ink collecting body 61 is larger than a predetermined amount, the suction pump 63 may be operated so as to suck the waste ink. Accordingly, before the waste ink accumulated in the cleaning belt 41 or the ink collecting body 61 is saturated, it may be possible to automatically discharge the waste ink to the waste ink tank 66 (see FIG. 11). Meanwhile, the amount of accumulated waste ink may be determined by a method appropriately selected from a method of directly detecting the change of a resistance value or capacitance between a pair of electrodes, a method of directly detecting the change in total weight, and a method of estimating the amount of accumulated waste ink from the number of times of cleaning operation or cleaning time.

### Second Embodiment

### Configuration Example of Liquid Discharge Apparatus

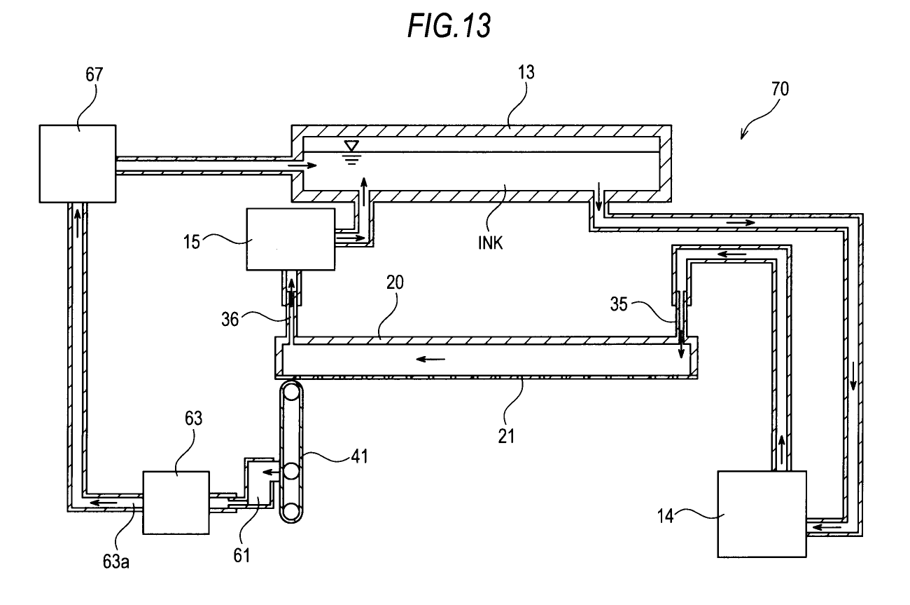

FIG. 13 is a schematic diagram of an ink path of an inkjet printer 70 as a liquid discharge apparatus according to an embodiment (second embodiment) of the invention.

As shown in FIG. 13, the inkjet printer 70 includes a cartridge 13 in which ink is stored, a sub-tank 14, a line head 20, and a circulating pump 15. Further, the ink stored in the cartridge 13 is supplied into the line head 20 from an ink supply port 35 through the sub-tank 14, and is discharged from an ink discharge surface 21.

Further, the ink existing in the line head 20 is discharged from the ink discharge port 36, and is returned to the cartridge 13 by the circulating pump 15. For this reason, the ink stored in the cartridge 13 is consumed only by the amount of ink that is discharged from the line head 20, and the rest is circulated by the circulating pump 15. Meanwhile, when ink is used up due to the discharge, the cartridge is replaced with a new cartridge 13 (in which ink is stored).

Here, standing ink and the like attached to the ink discharge surface 21 are adsorbed in a cleaning belt 41. Further, the waste ink adsorbed in the cleaning belt 41 is sucked through the ink collecting body 61 by a suction pump 63. Furthermore, in the inkjet printer 70 shown in the FIG. 13, a waste ink discharge port 63a (which corresponds to a liquid discharge port in the invention) of the suction pump 63 is connected to a filter 67 (which serves as a reuse unit in the invention). In addition the filter 67 is connected to the cartridge 13.

In the inkjet printer 70 shown in FIG. 13, the waste ink, which is adsorbed in the cleaning belt 41 and discharged from the waste ink discharge port 63a of the suction pump 63 as described above, is sent to the filter 67. Further, dirt or solidified ink is removed from the waste ink by the filter 67, and the ink is supplied to the ink supply port 35 through the cartridge 13 and the sub-tank 14. Accordingly, the waste ink may be reused and ink is efficiently and effectively used. Meanwhile, if an ink collecting body, which has specification taking the function of the filter into consideration, is used as a reuse unit, it may be possible to reuse waste ink after filtering the waste ink without the filter 67.

As described above, according to the inkjet printers 10 and 70 (and the method of controlling the inkjet printer 10) of this embodiment, it may be possible to typically maintain the adsorbability of the cleaning belt 41 high by the suction of the suction pump 63. Accordingly, it may be possible to restore the cleaning performance without the replacement or wringing of the cleaning belt 41, and to wipe off the ink discharge surface 21 without contamination that is caused by the wiping off or the reverse transfer of ink. As a result, the embodiment of the invention is particularly effective for the line head 20 that has a large cleaning range and a large amount of adsorbed ink, and it may be possible to obtain a uniform cleaning effect where wiping unevenness is not generated over the entire ink discharge surface 21.

Furthermore, the wiping portion is changed by rotating the endless cleaning belt 41 at a predetermined timing, so that cleaning performance may be rapidly restored by the suction of the suction pump 63 and natural drying. For this reason, it is the necessary that a cleaning/maintenance program (the flowchart shown in FIG. 12) is not necessarily executed whenever printing is performed.

In addition, the invention is not limited to the above-mentioned embodiment, and may have the following various modifications. That is,

(1) This embodiment has been applied to each of the line inkjet printers 10 and 70 including the line heads 20, but is not limited thereto. This embodiment may also be applied to a serial printer that performs printing while moving a head in the width direction of a recording sheet. Further, this embodiment may also be applied to a copying machine, a facsimile, and the like in addition to the printer.

(2) The endless cleaning belt 41 made of a foam has been employed as a liquid adsorbent in this embodiment, but a cleaning roller may be employed as a liquid adsorbent. Further, as long as the cleaning belt can adsorb liquid, any material may be used to make the cleaning belt. Furthermore, the wiping portion has been changed by the rotation of the cleaning belt 41 in this embodiment, but the number of times of the rotation of the cleaning belt is not limited. In addition, the cleaning belt 41 has not been rotated during the movement of the belt frame 43 in this embodiment, but may be rotated in accordance with or regardless of the moving speed of the belt frame.

(3) The guide shaft 52, the moving drive belt 53, the moving drive pulley 54, the tension pulley 55, the belt driving motor 56, and the movement transmitting belt 57 have been used as the moving unit for the belt frame 43 in this embodiment. However, the moving unit for the belt frame is not limited thereto, and may be formed of a gear, a belt, a cam, a piston, or a combination thereof. Further, the belt rotating motor 46, the rotational drive pulley 47, the rotation transmitting belt 48, and the rotational drive belt 49 have been used as the rotational drive unit for the installation roller 42 in this embodiment. However, the rotational drive unit for the installation roller is not limited thereto, and may be formed of a gear, a belt, a cam, a piston, or a combination thereof.

The present application contains subject matter related to that disclosed in Japanese Priority Patent Application JP 2009-030535 filed in the Japan Patent Office on Feb. 12, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid discharge apparatus comprising:
a plurality of nozzles that discharges liquid;
a liquid discharge head that includes nozzle arrays where the respective nozzles are arranged in one direction;
a liquid adsorbent that adsorbs liquid attached to a portion of the liquid discharge head where the nozzle arrays are formed;
a moving means for relatively moving the liquid adsorbent in an arrangement direction of the nozzles; and
a liquid suction means for sucking liquid adsorbed in the liquid adsorbent.

2. The liquid discharge apparatus according to claim 1, further comprising:
a liquid collecting body that collects liquid adsorbed in the liquid adsorbent,
wherein the liquid suction means sucks liquid that is collected in the liquid collecting body.

3. The liquid discharge apparatus according to claim 1,
wherein the liquid adsorbent is an endless cleaning belt,
the liquid discharge apparatus further comprising:
installation rollers where the cleaning belt is rotatably installed;
a support frame that supports the installation rollers so that an angle is formed between the width direction of the cleaning belt and the arrangement direction of the nozzles and the cleaning belt positioned on the peripheral surface of the installation roller comes into contact with the portion of the liquid discharge head where the nozzle arrays are formed; and
a rotational drive means for rotationally driving the installation roller.

4. The liquid discharge apparatus according to claim 1, further comprising:
a liquid supply port through which liquid is supplied to the liquid discharge head;
a liquid discharge port through which liquid is discharged from the liquid suction means; and
a reuse means for supplying liquid discharged from the liquid discharge port to the liquid supply port and reusing the liquid.

5. A method of controlling a liquid discharge apparatus, the liquid discharge apparatus including a plurality of nozzles that discharges liquid, a liquid discharge head that includes nozzle arrays where the respective nozzles are arranged in one direction, a liquid adsorbent that adsorbs liquid attached to a portion of the liquid discharge head where the nozzle arrays are formed, a moving means for relatively moving the liquid adsorbent in an arrangement direction of the nozzles, and a liquid suction means for sucking liquid adsorbed in the liquid adsorbent, the method comprising the step of:
allowing the liquid suction means to suck liquid from the liquid adsorbent when the amount of liquid adsorbed in the liquid adsorbent is larger than a predetermined amount.

6. A method of controlling a liquid discharge apparatus, the liquid discharge apparatus including a plurality of nozzles that discharges liquid, a liquid discharge head that includes nozzle arrays where the respective nozzles are arranged in one direction, a liquid adsorbent that adsorbs liquid attached to a portion of the liquid discharge head where the nozzle arrays are formed, a moving means for relatively moving the liquid adsorbent in an arrangement direction of the nozzles, a liquid collecting body that collects liquid adsorbed in the liquid adsorbent, and a liquid suction means for sucking liquid collected in the liquid collecting body, the method comprising the step of:
allowing the liquid suction means to suck liquid from the liquid collecting body when the amount of liquid collected in the liquid collecting body is larger than a predetermined amount.

7. A method of controlling a liquid discharge apparatus, the liquid discharge apparatus including a plurality of nozzles that discharges liquid, a liquid discharge head that includes nozzle arrays where the respective nozzles are arranged in one direction, a liquid adsorbent that adsorbs liquid attached to a portion of the liquid discharge head where the nozzle arrays are formed, a moving means for moving the liquid adsorbent in an arrangement direction of the nozzles, a liquid collecting body that collects liquid adsorbed in the liquid adsorbent, and a liquid suction means for sucking liquid through the liquid collecting body, the method comprising the step of:
allowing the moving means to move the liquid adsorbent so that the liquid adsorbent comes into contact with the liquid collecting body, and
allowing the liquid suction means to suck liquid when the liquid adsorbent comes into contact with the liquid collecting body.

8. The method according to claim 7,
wherein the liquid adsorbent is an endless cleaning belt,
the liquid discharge apparatus further including:
installation rollers where the cleaning belt is rotatably installed;
a support frame that supports the installation rollers so that an angle is formed between the width direction of the cleaning belt and the arrangement direction of the nozzles and the cleaning belt positioned on the peripheral surface of the installation roller comes into contact with the portion of the liquid discharge head where the nozzle arrays are formed; and
a rotational drive means for rotationally driving the installation roller,
wherein the rotational drive means rotationally drives the installation rollers so that a portion of the cleaning belt positioned on the peripheral surface of the installation roller faces the liquid collecting body.

9. A liquid discharge apparatus comprising:
a plurality of nozzles that discharges liquid;
a liquid discharge head that includes nozzle arrays where the respective nozzles are arranged in one direction;
a liquid adsorbent that adsorbs liquid attached to a portion of the liquid discharge head where the nozzle arrays are formed;
a moving unit configured to relatively move the liquid adsorbent in an arrangement direction of the nozzles; and
a liquid suction unit configured to suck liquid adsorbed in the liquid adsorbent.
